(19) United States
(12) Patent Application Publication
(10) Pub. No.: US 2003/0027889 A1
(43) Pub. Date: Feb. 6, 2003

(54) Antimicrobial paste glues

(75) Inventors: Martina Inhester, Herten (DE); Peter Ottersbach, Windeck (DE); Beate Kossmann, Hagen (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CREAVIS GESELLSCHAFT F. TECHN. U. INNOVATION MBH, Marl (DE)

(21) Appl. No.: 10/198,146

(22) Filed: Jul. 19, 2002

(30) Foreign Application Priority Data
Jul. 19, 2001 (DE) 101 35 162.3

(51) Int. Cl. C08K 3/00

(52) U.S. Cl. 523/122

(57) ABSTRACT

An antimicrobial paste glue is provided, which includes from 0.01 to 70% by weight of at least one antimicrobial compound, based on the weight of solids. Other embodiments of the invention provide methods of making and using the paste glue.

### FIELD OF THE INVENTION

The invention relates to antimicrobial paste glues, their preparation and use.

### DISCUSSION OF THE BACKGROUND

It is highly undesirable for bacteria to become established or to spread on the surfaces of piping, containers, or packaging. Frequently, slime layers form and permit sharp rises in microbial populations, and these can lead to the persistent impairment of the quality of water, drinks or foods, and to the spoilage of the product and harm to the health of consumers.

Bacteria must be kept away from all fields of life in which hygiene is important. This includes textiles for direct body contact, particularly in the genital area, and for the care of the sick and elderly. Bacteria must also be kept away from surfaces of the furniture and instruments used in patient-care areas, particularly in the areas of intensive care or neonatal care, in hospitals and particularly in areas for medical intervention, in isolation wards for critical cases of infection, and in toilets.

There are many industrial systems whose performance can be severely limited, or which can be rendered entirely unusable by the growth of microbes. Systems for separating materials, e.g. membranes or filters, are particularly severely impaired by the deposition and growth of microbes. For example, in seawater desalination systems, the growth of marine algae shortens running times, often considerably. In other systems, e.g. deep-bed filtration, the filter cake can become blocked prematurely as a result of biofilm growth. Crossflow filtration attempts to counter this effect by using a specified flow perpendicular to the plane of filtration, but this is not industrially adequate to prevent the growth of biofilms.

A current method for treating equipment or the surfaces of furniture or textiles to resist bacteria, either when necessary or as a precautionary measure, is to use chemicals, solutions, or mixtures thereof which are disinfecting and which have fairly broad general antimicrobial action. Chemical agents of this type act nonspecifically, are themselves frequently toxic or irritating, or form degradation products which are health hazards. In addition, people frequently exhibit intolerance to these materials once they have become sensitized.

The elimination of microbes, particularly mold infestation, from interior surfaces in buildings, particularly interior surfaces of occupied areas, is very important in preventative health care. Surfaces covered with wallcoverings are particularly critical in this connection, since the wallcoverings prevent the building material from “breathing”; and this firstly exacerbates condensation of atmospheric moisture and secondly reduces moisture dissipation from, and therefore drying of, damp walls. Since the use of wallcoverings is more popular in Germany than anywhere else in the world, the importance of this fact is increased. Statistically, each German citizen hangs almost two rolls of wallcoverings every year, which amounts to a total amount of about 140 million rolls of wall covering. For the production of foamed vinyl wallcoverings alone, 25,000 metric tons of PVC paste are used annually in Germany, and the trend is increasing.

The popular vinyl wallcoverings also pose particular problems in relation to moisture transmission. For example, water-vapor permeability, which is classified by DIN 52615 (the entire contents of which are hereby incorporated by reference) by taking an equivalent air layer thickness, ranges from 5 to 10 centimeters for paper wallcoverings, but it ranges from 200 to 300 centimeters for PVC wallcoverings. This means that the breathability is markedly less for vinyl wallcoverings than for paper wallcoverings.

A consequence of this reduced breathability is that moisture condenses between the wall and the wallcovering, at the interface between the wall and the paste glue, or at the interface between the wallcovering and the paste glue. The condensation increases mold formation, which is additionally stimulated by the organic constituents of the paste glue because at least some of the glue constituents can be metabolized by the microorganisms. In addition, vinyl wallcoverings often contain an admixture of low-molecular weight plasticizers, which themselves can be metabolized by microorganisms and thus further stimulate microbial growth. Since microbial growth often takes place beneath the visible surface, contaminated sites are also very difficult to identify visually. This is why these problems are often first detected through their adverse health effects in the form of diseases of the skin or the respiratory tract, or allergic reactions in the persons affected, being induced by mold spores in the ambient air. In room air tests, which have taken place from time to time in Germany, molds of the genera Aspergillus and Cladosporium are most frequently detected.

It is clear that paste glues having antimicrobial properties could eliminate or suppress microbial infestation, which arises at least in part from the presence of moisture and nutrients from surface materials, e.g. from the plasticizers and paste glue constituents described, especially in the case of wallcoverings which inhibit water-vapor permeation, e.g. vinyl wallcoverings. Conventional biocides or disinfectants, e.g. sodium hypochlorite, formaldehyde, or isothiazoline derivatives, are unsuitable for these applications because of their acute toxicity and their known allergenic potential. In addition, these compounds are relatively rapidly consumed, with the result that either the protection disappears after a relatively short time or additional amounts of these toxic substances must be used.

### SUMMARY OF THE INVENTION

Accordingly, one object of the invention is to provide a material, which exhibits efficient and prolonged microbicidal action.

Another object of the invention is to provide a material, which has very little or no toxicity to higher organisms, is not dissipated into the room air, and has almost no effect on the performance of the material to be impregnated.

Another object of the invention is the prevention or long-term suppression of microbicidal infestation of wallcoverings.

These and other objects have been attained by the present invention, the first embodiment of which provides an antimicrobial paste glue, which includes from 0.01 to 70% by weight of at least one antimicrobial compound based on the weight of solids.

Another embodiment of the present invention provides an antimicrobial paste glue, which includes from 0.01 to 70% by weight of at least one antimicrobial compound, and a means for adhering to a surface.

Another embodiment of the present invention provides a method, which includes:

inhibiting microbial, fungal or bacterial growth on a surface or interface by contacting said surface or interface with the above antimicrobial paste glue.

Another embodiment of the present invention provides a method, which includes:

reducing or inhibiting the amount of mold spores in a volume of air bound by at least one surface, which includes contacting the surface with the above antimicrobial paste glue.

Another embodiment of the present invention provides an article, which includes the above antimicrobial paste glue in contact with at least one selected from the group including paper, vinyl, wallcovering, wood, plastic, and combinations thereof.

Another embodiment of the present invention provides a method, which includes contacting the above antimicrobial paste glue with at least one surface in a building, office, room, or dwelling.

### DETAILED DESCRIPTION OF THE PREFERRED EMBODIMENTS

A more complete appreciation of the invention and many of the attendant advantages thereof will be readily obtained as the same becomes better understood by reference to the following detailed description.

Preferably, the present invention provides antimicrobial paste glues where the dry paste glue includes from 0.01 to 70% by weight of at least one antimicrobial compound.

For the purposes of the present invention, paste glues are compounds or mixtures as defined in Rompp Lexikon Chemie (Rompp's Chemical Encyclopedia), Georg Thieme Verlag, 1999, the entire contents of which are hereby incorporated by reference. The definition of paste glues preferably includes one in which they are adhesives in the form of an aqueous product, which swells and, unlike other glues, even at low solids concentration forms a non-stringy, high-viscosity mass.

The base raw materials for paste glues are preferably products of natural origin, such as flour, starch, and also water-soluble derivatives (ethers) of cellulose and starch. These are suspended in about 4-7 times (weight or volume) (flour, starch) or 20-50 times (cellulose, starch derivatives) the amount of water. Cellulose ethers (carboxymethyl- and methylcelluloses) and starch ethers (e.g. carboxymethyl starch) are converted to paste glue in cold water, but flour and native starch are converted at higher temperatures (about 80-100° C.). The above ranges include all values and subranges therebetween, including 4,5, 5, 5.5, 6 and 6.5 (flour, starch); 22, 25, 30, 35, 40 and 45 (cellulose, starch derivatives); and 83, 85, 87, 90, 93, 95 and 97° C.

The shortcomings of paste glues based on natural products, particularly susceptibility to microbial damage, can be eliminated by using the paste glue systems of the invention without addition of preservatives. The base for the paste glue systems of the invention may therefore include natural, i.e. renewable raw materials.

The paste glue systems of the invention are particularly suitable for paper, wood, or wallcoverings, for example.

The terms, microbial, fungal, and bacterial, and their derivatives, are used herein interchangeably.

“Dry paste glue” denotes the non-swollen, dry material. Antimicrobial compounds, which may be used in the paste glues of the invention, include antimicrobial polymers or amino alcohols. The amount of the antimicrobial compounds present in the paste glue of the invention may be from 0.01 to 70% by weight based on the weight of the dry paste glue, preferably from 0.1 to 40% by weight, in particular from 0.1 to 30% by weight, or from 0.1 to 20% by weight, or from 0.1 to 15% by weight. These ranges include all values and subranges therebetween including 0.05, 1, 5, 10, 25, 35, 45, 55 and 65% by weight.

A preferred embodiment includes a ready-to-use wet glue composition, which includes the antimicrobial paste glue of the invention and water, wherein the weight ratio of the antimicrobial paste glue to water ranges from 1:20 to 1:80. This range includes all values and subranges therebetween, including (1:)21, 23, 25, 30, 35, 0, 45, 50, 55, 60, 65, 70, 75, 77 and 79 as appropriate.

Preferable amino alcohols which may be used include any of the amino-functionalized derivatives of alcohols, but are more preferably those of the following formula I

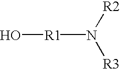

where

R1=branched or unbranched aliphatic or aromatic hydrocarbon diradicals having from 1 to 15 carbon atoms. These include C1, C2, C3, C4, C5, C6, C7, C8, C9, C10, C11, C12, C13, C14 and C15 hydrocarbons as appropriate.

R2=H, or branched or unbranched aliphatic or aromatic hydrocarbon radical having from 1 to 15 carbon atoms. These include C1, C2, C3, C4, C5, C6, C7, C8, C9, C10, C11, C12, C13, C14 and C15 hydrocarbons as appropriate.

R3=H, or branched or unbranched aliphatic or aromatic hydrocarbon radical having from 1 to 15 carbon atoms. These include C1, C2, C3, C4, C5, C6, C7, C8, C9, C10, C11, C12, C13, C14 and C15 hydrocarbons as appropriate.

Preferred alcohols of the formula (I) include tert-butylaminoethanol, tert-butylaminomethanol, tert-butylaminopropanol, 2-butylaminoethanol, 2-butylaminomethanol, 2-butylaminopropanol, 2-diethylaminoethanol, 2-diethylaminomethanol, 2-diethylaminopropanol, 2-dimethylaminoethanol, 2-dimethylaminomethanol, 2-dimethylaminopropanol, aminomethanol, aminoethanol, aminopropanol and/or aminobutanol. Mixtures are possible.

The proportion of the amino alcohols in the paste glues may be from 0.1 to 40% by weight based on the weight of the dry paste glue, preferably from 0.1 to 30% by weight, particularly preferably from 0.1 to 15% by weight. These ranges include all values and subranges therebetween, including 0.5, 1, 2, 5, 10, 20, 25, and 35%.

Preferably, the antimicrobial polymers may include the polymers described in European Patent Application 0 862 858 or from the patent applications DE 100 24 270, DE 100 22 406, PCT/EP00/06501, DE 100 14 726, DE 100 08 177, PCT/EP00/06812, PCT/EP00/06487, PCT/EP00/06506, PCT/EP00/02813, PCT/EP00/02819, PCT/EP00/02818, PCT/EP00/02780, PCT/EP00/02781, PCT/EP00/02783, PCT/EP00/02782, PCT/EP00/02799, PCT/EP00/02798, PCT/EP00/00545, PCT/EP00/00544, the entire contents of each of which are hereby incorporated by reference.

Preferably, the antimicrobial polymers do not contain low-molecular-weight constituents, and the antimicrobial properties are believed to arise from the contact of bacteria with the polymer surface.

It is preferable to use nitrogen- or phosphorus-functionalized monomers for preparing the antimicrobial polymers. These polymers are preferably prepared from the polymerization of at least one of the follow monomers: 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylamino-propylmethacrylamide, diethylaminopropylmethacrylamide, N-3-dimethylaminopropylacrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether. Combinations of monomers are possible.

Other aliphatically unsaturated monomers may additionally and optionally be used in preparing the antimicrobial polymers. These include acrylates or methacrylates, e.g. acrylic acid, tert-butyl methacrylate, methyl methacrylate, styrene and its derivatives, vinyl chloride, vinyl ethers, acrylamides, acrylonitriles, olefins (ethylene, propylene, butylene, isobutylene), allyl compounds, vinyl ketones, vinylacetic acid, vinyl acetate and vinyl esters, e.g. in particular methyl methacrylate, methyl methacrylate, butyl methacrylate, tert-butyl methacrylate, methyl acrylate, ethyl acrylate, butyl acrylate and tert-butyl acrylate. Combinations are possible.

The proportion of the antimicrobial polymers in the paste glues may be from 0.01 to 70% by weight based on the weight of the paste glue dry, preferably from 0.1 to 40% by weight, particularly preferably from 0.1 to 20% by weight. These ranges include all values and subranges therebetween, including 0.05, 0.5, 1, 2, 5, 10, 15, 25, 35, 45, 55, 60 and 65%. As an alternative to the direct admixture of the antimicrobial polymers into a conventional dried finished paste glue concentrate, it is, of course, also possible to add an antimicrobial aqueous emulsion prepared from an antimicrobial polymer directly into the mixed, ready-to-use paste glue.

The process for preparing the paste glue preferably includes one in which, during the course of the process for preparing the paste glues, or following the same, at least one antimicrobial compound, e.g., an amino alcohol or an antimicrobial polymer, is added. It is believed that, during the swelling or solvating process, at least some reaction of the antimicrobial polymer or of the amino alcohol takes place with the other constituents of the formulation, in particular the methyl cellulose.

It is preferable that during the course of the reaction the amino alcohol is either incorporated into the polymeric network which forms or else, in the absence of suitable reaction partners, is fixed by way of its hydroxyl or amino function to the polymeric network of the dried paste glue film as it forms. Possible coupling reactions include for example any reaction found in organic chemistry involving the reaction of hydroxyl or amino groups to form chemical bonds, e.g. esterification or etherification. In addition, purely physical coupling mechanisms, e.g. physisorption, are also believed to play a decisive part.

The paste glues of the invention may be further processed with any of the products based on unmodified paste glues. This applies in particular to applications of the paste glues for wallcoverings, paper wallcoverings, vinyl wallcoverings, woodchip wallcoverings, textile wallcoverings, or natural-fiber wallcoverings.

The present invention provides antimicrobial paste glues, which combine in an almost ideal manner the mechanical and processing properties required for the objects set with biochemical inhibitory action for microbial growth. Since both the preferred amino alcohol and polymers are generally of low volatility and, due to the preparation process, are at least to some extent fixed within the matrix of the paste glue, there is no release of hazardous low-molecular-weight constituents into the environment, nor into the air in the room. The present invention is particularly suitable in sensitive areas, e.g. for lining rooms used by allergy sufferers or bedrooms, without any likelihood that there will be toxicologically hazardous migration of biocides out of the product.

The paste glues of the invention are also particularly suitable in wallcoverings, for paper, or for wood.

### EXAMPLES

Having generally described this invention, a further understanding can be obtained by reference to certain specific examples which are provided herein for purposes of illustration only and are not intended to be limiting unless otherwise specified.

### Example 1

0.6 g of 2-tert-butylaminoethanol are mixed with 3.4 g of TTW Normal paste glue (Wilke, Magdeburg). 280 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 1a

A section of dimensions 2×3 cm from the coated aluminum plate of example 1 is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10⁷ to 10² per ml.

### Example 1b

A section of dimensions 2×3 cm from the coated aluminum plate of example 1 is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, no remaining Staphylococcus aureus microbes are detectable.

### Example 1c

Sections of dimensions 2×3 cm from the coated aluminum plate of example 1 are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 2

0.3 g of 2-tert-butylaminoethanol are mixed with 3.7 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 2a

A section of dimensions 2×3 cm from the coated aluminum plate of example 2 is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10⁷ to 10⁴ per ml.

### Example 2b

A section of dimensions 2×3 cm from the coated aluminum plate of example 2 is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, the number of microbes has fallen from 10⁷ to 10³ per ml.

### Example 2c

Sections of dimensions 2×3 cm from the coated aluminum plate of example 2 are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and arc made from unmodified paste glue, none of the modified paste glue specimens exhibits any detectable growth.

### Example 3

0.6 g of 3-aminopropanol are mixed with 3.4 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 3a

A section of dimensions 2×3 cm from the coated aluminum plate of example 3 is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10⁷ to 10² per ml.

### Example 3b

A section of dimensions 2×3 cm from the coated aluminum plate of example 3 is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, no remaining Staphylococcus aureus microbes are detectable.

### Example 3c

Sections of dimensions 2×3 cm from the coated aluminum plate of example 3 are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 4

0.6 g of 2-butylaminoethanol are mixed with 3.4 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 4a

A section of dimensions 2×3 cm from the coated aluminum plate of example 4 is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10⁷ to 10⁴ per ml.

### Example 4b

A section of dimensions 2×3 cm from the coated aluminum plate of example 4 is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, the number of microbes has fallen from 10⁷ to 10³ per ml.

### Example 4c

Sections of dimensions 2×3 cm from the coated aluminum plate of example 4 are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 5

0.6 g of tert-butylaminopropanol are mixed with 3.4 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 5a

A section of dimensions 2×3 cm from the coated aluminum plate of example 5 is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10⁷ to 10⁴ per ml.

### Example 5b

A section of dimensions 2×3 cm from the coated aluminum plate of example 5 is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, the number of microbes has fallen from 10⁷ to 10² per ml.

### Example 5c

Sections of dimensions 2×3 cm from the coated aluminum plate of example 5 are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 6

40 ml of dimethylaminopropylmethacrylamide (Aldrich) and 200 ml of ethanol are charged to a three-necked flask and heated to 65° C. under a stream of argon. 0.4 g of azobisisobutyronitrile dissolved in 20 ml of ethanol are then slowly added dropwise, with stirring. The mixture is heated to 70° C. and stirred at this temperature for 6 hours. After expiration of this time, the solvent is removed from the reaction mixture by distillation, and the reaction mixture is dried in vacuo at 50° C. for 24 hours. The product is then dissolved in 200 ml of acetone, and the solvent is then removed from the reaction mixture by distillation, and the reaction mixture is dried in vacuo at 50° C. for 24 hours. The product from the reaction is then finely ground in a mortar.

### Example 6a

0.6 g of the product from example 6 are finely ground in a mortar and mixed with 3.4 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 6b

A section of dimensions 2×3 cm from the coated aluminum plate of example 6a is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10⁷ to 10⁴ per ml.

### Example 6c

A section of dimensions 2×3 cm from the coated aluminum plate of example 6a is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, no remaining Staphylococcus aureus microbes are detectable.

### Example 6d

Sections of dimensions 2×3 cm from the coated aluminum plate of example 6a are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 7

40 mL of tert-butylaminoethyl methacrylate (Aldrich) and 210 mL of ethanol are charged to a three-necked flask and heated to 65° C. under a stream of argon. 0.4 g of azobisisobutyronitrile dissolved in 20 mL of ethanol are then slowly added dropwise, with stirring. The mixture is heated to 70° C. and stirred at this temperature for 6 hours. After expiration of this time, the solvent is removed from the reaction mixture by distillation, and the product is dried in vacuo at 50° C. for 24 hours. The product is then dissolved in 200 ml of acetone, and the solvent is then removed from the reaction mixture by distillation, and the reaction mixture is dried in vacuo at 50° C. for 24 hours.

### Example 7a

0.6 g of the product from example 7 are finely ground in a mortar and mixed with 3.4 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 7b

A section of dimensions 2×3 cm from the coated aluminum plate of example 7a is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10⁷ to 10³ per ml.

### Example 7c

A section of dimensions 2×3 cm from the coated aluminum plate of example 7a is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, no remaining Staphylococcus aureus microbes are detectable.

### Example 7d

Sections of dimensions 2×3 cm from the coated aluminum plate of example 7a are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 7e

1 g of the product from example 7 are finely ground in a mortar and mixed with 3 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 7f

A section of dimensions 2×3 cm from the coated aluminum plate of example 7e is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, no remaining Pseudomonas aeruginosa microbes are detectable.

### Example 7g

A section of dimensions 2×3 cm from the coated aluminum plate of example 7e is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, no remaining Staphylococcus aureus microbes are detectable.

### Example 7h

Sections of dimensions 2×3 cm from the coated aluminum plate of example 7e are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 7i

1.6 g of the product from example 7 are finely ground in a mortar and mixed with 2.4 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 7j

A section of dimensions 2×3 cm from the coated aluminum plate of example 7i is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, no remaining Pseudomonas aeruginosa microbes are detectable.

### Example 7k

A section of dimensions 2×3 cm from the coated aluminum plate of example 7i is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, no remaining Staphylococcus aureus microbes are detectable.

### Example 7l

Sections of dimensions 2×3 cm from the coated aluminum plate of example 7i are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 7m

0.2 g of the product from example 7 are finely ground in a mortar and mixed with 3.8 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 7n

A section of dimensions 2×3 cm from the coated aluminum plate of example 7m is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10⁷ to 10⁴ per ml.

### Example 7o

A section of dimensions 2×3 cm from the coated aluminum plate of example 7m is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, the number of microbes has fallen from 10⁷ to 10⁴ per ml.

### Example 7p

Sections of dimensions 2×3 cm from the coated aluminum plate of example 7m are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 7q

0.1 g of the product from example 7 are finely ground in a mortar and mixed with 3.9 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 7r

A section of dimensions 2×3 cm from the coated aluminum plate of example 7q is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10⁷ to 10⁵ per ml.

### Example 7s

A section of dimensions 2×3 cm from the coated aluminum plate of example 7q is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, the number of microbes has fallen from 10⁷ to 10⁵ per ml.

### Example 7t

Sections of dimensions 2×3 cm from the coated aluminum plate of example 7q are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 8

6 g of 3-aminopropyl vinyl ether (Aldrich), 6 g of methyl methacrylate (Aldrich) and 60 ml of ethanol are charged to a three-necked flask and heated to 65° C. under a stream of argon. 0.15 g of azobisisobutyronitrile dissolved in 4 ml of ethyl methyl ketone are then slowly added dropwise, with stirring. The mixture is heated to 70° C. and stirred at this temperature for 72 h. After expiration of this time, the reaction mixture is stirred into 0.5 1 of deionized water, whereupon the polymeric product precipitates. After the product has been separated by filtration, the filter residue is rinsed with 100 ml of deionized water in order to remove any residual monomers still present. The product is then dried in vacuo at 50° C. for 24 hours.

### Example 8a

1.6 g of the product from example 8 are finely ground in a mortar and mixed with 2.4 g of TTW Normal paste glue (Wilke, Magdeburg). 208 ml of water are added to this mixture, and the mixture is then stirred for 1 hour. 5 g of the resultant paste glue mixture are spread onto an aluminum plate of dimensions 20×40 cm and then dried for a period of 72 hours at 30° C.

### Example 8b

A section of dimensions 2×3 cm from the coated aluminum plate of example 8a is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, no remaining Pseudomonas aeruginosa microbes are detectable.

### Example 8c

A section of dimensions 2×3 cm from the coated aluminum plate of example 8a is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, no remaining Staphylococcus aureus microbes are detectable.

### Example 8d

Sections of dimensions 2×3 cm from the coated aluminum plate of example 8a are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 9

2 ml of tert-butylaminoethyl methacrylate (Aldrich), 5.7 g of triton X 405 (Aldrich), 25 ml of deionized water, and 0.08 g of potassium peroxodisulfate (Aldrich) are charged to a three-necked flask and heated to 60° C. under a stream of argon. A further 23 ml of tert-butylaminoethyl methacrylate are then added dropwise over a period of 4 hours. The mixture is then stirred for a further 2 hours at 60° C., and the resultant emulsion is allowed to cool to room temperature.

### Example 9a

4 g of TTW Normal paste glue (Wilke, Magdeburg) are mixed with 208 ml of water and the mixture is then stirred for I hour. 1 g of the product from example 9 is added to this mixture, and the mixture is then stirred for a further hour. 5 g of the resultant paste glue mixture are spread onto an aluminum plate of dimensions 20×40 cm and then dried for a period of 72 hours at 30° C.

### Example 9b

A section of dimensions 2×3 cm from the coated aluminum plate of example 9a is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, no remaining Pseudomonas aeruginosa microbes are detectable.

### Example 9c

A section of dimensions 2×3 cm from the coated aluminum plate of example 9a is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, no remaining Staphylococcus aureus microbes are detectable.

### Example 9d

Sections of dimensions 2×3 cm from the coated aluminum plate of example 9a are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 9e

4 g of TTW Normal paste glue (Wilke, Magdeburg) are mixed with 208 ml of water and the mixture is then stirred for 1 hour. 2 g of the product from example 9 are added to this mixture, and the mixture is then stirred for a further hour. 5 g of the resultant paste glue mixture are spread onto an aluminum plate of dimensions 20×40 cm and then dried for a period of 72 hours at 30° C.

### Example 9f

A section of dimensions 2×3 cm from the coated aluminum plate of example 9e is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, no remaining Pseudomonas aeruginosa microbes are detectable.

### Example 9g

A section of dimensions 2×3 cm from the coated aluminum plate of example 9e is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, no remaining Staphylococcus aureus microbes are detectable.

### Example 9h

Sections of dimensions 2×3 cm from the coated aluminum plate of example 9e are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

### Example 9i

4 g of TTW Normal paste glue (Wilke, Magdeburg) are mixed with 208 ml of water and the mixture is then stirred for 1 hour. 0.25 g of the product from example 9 is added to this mixture, and the mixture is then stirred for a further hour. 5 g of the resultant paste glue mixture are spread onto an aluminum plate of dimensions 20×40 cm and then dried for a period of 72 hours at 30° C.

### Example 9j

A section of dimensions 2×3 cm from the coated aluminum plate of example 9i is placed on the base of a glass beaker which contains 10 ml of a test microbial suspension of Pseudomonas aeruginosa. The system prepared in this way is then shaken for a period of 4 hours. 1 ml of the test microbial suspension is then removed. After expiration of this period, the number of microbes has fallen from 10¹ to 10⁴ per ml.

### Example 9k

A section of dimensions 2×3 cm from the coated aluminum plate of example 9i is placed on the base of a glass beaker which contains 10 ml of a test microbial suspension of Staphylococcus aureus. The system prepared in this way is then shaken for a period of 4 hours. 1 ml of the test microbial suspension is then removed. After expiration of this period, the number of microbes has fallen from 10⁷ to 10⁴ per ml.

### Example 9l

Sections of dimensions 2×3 cm from the coated aluminum plate of example 9i are inoculated with, respectively, Chlorella sp., Trentepohlia sp., Gloeocapsa sp. Calothrix sp., and Aspergilus niger. These specimens are then placed in an incubator for 3 weeks. Unlike control specimens which run simultaneously and are made from unmodified paste glue, none of the modified paste glue specimens exhibits any detectable growth.

Obviously, numerous modifications and variations of the present invention are possible in light of the above teachings. It is therefore to be understood that within the scope of the appended claims, the invention may be practised otherwise than as specifically described herein.

This application is based on German patent application DE 10135162.3, filed Jul. 19, 2001, the entire contents of which are hereby incorporated by reference.

1. An antimicrobial paste glue, comprising from 0.01 to 70% by weight of at least one antimicrobial compound, based on the weight of solids.

2. The antimicrobial paste glue as claimed in claim 1, wherein the antimicrobial compound comprises at least one antimicrobial polymer.

3. The antimicrobial paste glue as claimed in claim 1, wherein the antimicrobial compound comprises at least one antimicrobial polymer comprising at least one polymerized monomer unit selected from the group consisting of nitrogen-functionalized monomer unit, phosphorus-functionalized monomer unit, and combinations thereof.

4. The antimicrobial paste glue as claimed in claim 1, wherein the antimicrobial compound comprises at least one antimicrobial polymer comprising at least one polymerized monomer unit selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenylphosphonium chloride, 2-acrylamido-2-methyl- 1 -propanesulfonic acid, 2-diethylaminoethyl vinyl ether, 3-aminopropyl vinyl ether, and combinations thereof.

5. The antimicrobial paste glue as claimed in claim 4, wherein said polymer further comprises at least one other polymerized aliphatically unsaturated monomer selected from the group consisting of acrylate, methacrylate, acrylic acid, tert-butyl methacrylate, methyl methacrylate, styrene and its derivatives, vinyl chloride, vinyl ether, acrylamide, acrylonitrile, olefins (ethylene, propylene, butylene, isobutylene), allyl compound, vinyl ketone, vinyl acetic acid, vinyl acetate and vinyl ester, methyl methacrylate, ethyl methacrylate, butyl methacrylate, tert-butyl methacrylate, methyl acrylate, ethyl acrylate, butyl acrylate and tert-butyl acrylate.

6. The antimicrobial paste glue as claimed in claim 1, wherein the antimicrobial compound comprises at least one amino alcohol.

7. The antimicrobial paste glue as claimed in claim 1, wherein the antimicrobial compound comprises at least one amino alcohol having the formula: 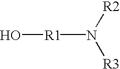
wherein
R1=branched or unbranched aliphatic or aromatic hydrocarbon radical having from 1 to 15 carbon atoms;
R2=H, or branched or unbranched aliphatic or aromatic hydrocarbon radical having from 1 to 15 carbon atoms; and
R3=H, or branched or unbranched aliphatic or aromatic hydrocarbon radical having from 1 to 15 carbon atoms.

8. The antimicrobial paste glue as claimed in claim 1, wherein the antimicrobial compound is selected from the group consisting of tert-butylaminoethanol, tert-butylaminomethanol, tert-butylaminopropanol, 2-butylaminoethanol, 2-butylaminomethanol, 2-butylaminopropanol, 2-diethylaminoethanol, 2-diethylaminomethanol, 2-diethylaminopropanol, 2-dimethylaminoethanol, 2-dimethylaminomethanol, 2-dimethylaminopropanol, aminomethanol, aminoethanol, aminopropanol, aminobutanol, and mixtures thereof.

9. The antimicrobial paste glue as claimed in claim 1, further comprising at least one adhesive raw material selected from the group consisting of product of natural origin, flour, starch, cellulose, water-soluble derivative of cellulose, water-soluble derivative of starch, cellulose ether, starch ether, carboxymethylcellulose, methylcellulose, carboxymethyl starch, and combinations thereof.

10. The antimicrobial paste glue as claimed in claim 1, which does not contain any preservative.

11. An antimicrobial paste glue, comprising from 0.01 to 70% by weight of at least one antimicrobial compound, and a means for adhering to a surface.

12. A method, comprising:
inhibiting microbial, fungal or bacterial growth on a surface or interface by contacting said surface or interface with the antimicrobial paste glue as claimed in claim 1.

13. A method, comprising:
reducing or inhibiting the amount of mold spores in a volume of air bound by at least one surface comprising contacting said surface with the antimicrobial paste glue as claimed in claim 1.

14. The method as claimed in claim 13, further comprising contacting said glue with at least one wallcovering.

15. An article, comprising the antimicrobial paste glue as claimed in claim 1 in contact with at least one selected from the group consisting of paper, vinyl, wallcovering, wood, plastic, and combinations thereof.

16. A method, comprising contacting the antimicrobial paste glue as claimed in claim 1 with at least one surface in a building, office, room, or dwelling.
